(19) United States
(12) Patent Application Publication
(10) Pub. No.: US 2004/0021829 A1
(43) Pub. Date: Feb. 5, 2004

(54) Multi-level optical signal generation

(76) Inventor: Robert Anthony Griffin, Northants (GB)

Correspondence Address: LAHIVE & COCKFIELD, LLP., 28 STATE STREET, BOSTON, MA, 02109, US

(21) Appl. No.: 10/362,309

(22) PCT Filed: Aug. 20, 2001
(86) PCT No.: PCT/GB01/03735

(30) Foreign Application Priority Data
Aug. 19, 2000 (GB) 0020462.8
Sep. 13, 2000 (GB) 0022606.8

(51) Int. Cl. G03B 21/26

(52) U.S. Cl. 353/30

(57) ABSTRACT

The use of multi-level signalling in optical links may provide an improvement in system capacity compared to conventional binary signalling. Unlike conventional electronic or radio systems, in optically amplified links where optical noise is dominant equally spaced signalling levels are not optimum. For these links, the use of signalling levels with quadratic spacing can provide the lowest bit error rate for a given signal power, allowing a 6 dB reduction in launched optical power. The invention described is an arrangement to produce multi-level optical signalling with quadratic spacing. A multi-level optical signal generator for generating a multi-level optical signal in optical links in response to two or mote electrical signals. A light source arrangement provides a respective optical signal for each electrical signal utilising either separate light sources corresponding to each electrical signal or preferably, a single light source and a beam splitter. Each optical signal is modulated in response to its respective electrical signal and the signals are combined to produce the multi-level optical signal, preferably with quadratic spacing.

This invention relates to generating multi-level optical signals. More especially, although not exclusively, this invention concerns a generator for generating such optical signals for use in a wavelength division multiplex (WDM) optical communications system which transmits data using return to zero (RZ) or non-return to zero (NRZ) signalling formats.

With ongoing developments in optically amplified dense wavelength division multiplex (DWDM) optical links as the backbone of point-to-point information transmission, the finite width of the Erbium gain bandwidth window of conventional Erbium-doped optical fibre amplifier (EDFAs) could become a significant obstacle to further increases in transmission capacity. Conventional EDFAs have a 35 nm gain bandwidth which corresponds to a spectral width of 4.4 THz. System demonstrations of several Tbit/s are already a reality, and the spectral efficiency, characterised by the value of bit/s/Hz transmitted, is becoming an important consideration.

Currently, high speed optical WDM transmission employs binary signalling, using either non-return to zero (NRZ) or return to zero (RZ) signalling formats, in which data is transmitted in the form of optical pulses having a single level (amplitude). In WDM systems several factors limit the minimum channel spacing for binary signalling, and in practice spectral efficiency is limited to −0.3 bit/s/Hz.

One technique which has been suggested which allows an improvement of spectral efficiency is the use of multi-level, often termed M-ary, signalling. In M-ary signalling, in each time period T, one of M symbols are transmitted. Each symbol corresponds to one of M possible levels (amplitudes). Whilst multi-level signalling allows increased spectral efficiency, a higher optical power is required to achieve acceptable bit error rates (BER) compared to binary signalling. It is hence desirable to minimise the error rate for a given signal-to-noise ratio.

In an optically amplified transmission system, the dominant noise source is Signal-ASE (amplified spontaneous emission) beat noise, which is signal dependent, i.e. the noise variance Φ² is proportional to received power. Conventionally, M-ary signals have equally spaced levels: that is designating the spacing between adjacent levels as A, the various levels are given by 0, A, 2A, . . . (M−1)A. Signal-ASE beat noise makes it more difficult to discriminate between the upper levels than between the lower levels. Designating the average values of the levels at the receiver by +iₖ, the Q-value for thresholding two levels is given by

$${Q}_{k} = \frac{⟨ {i}_{k} ⟩ - ⟨ {i}_{k - 1} ⟩}{{σ}_{k} + {σ}_{k - 1}}$$

where σₖ² is the variance of the noise associated with level k.

It has been proposed (S. Walklin and J. Conradi, “Multilevel signaling for increasing the reach of 10 Gb/s lightwave systems”, J. Lightwave Technol., vol. 17, pp. 2235-2248, 1999) to optimise the BER performance by using a multi-level signalling having a quadratic spacing of the levels, i.e. the various levels are given by 0, A, 4A, . . . , (M−1)²A.

In the known arrangements, such as that disclosed in U.S. Pat. No. 5,510,919, multi-level optical signals are generated by summing the electrical data to form a multi-level electrical signal and then converting this to a multi-level optical signal by driving a semiconductor laser using the multi-level electrical signal. A disadvantage of such an arrangement is that its transmission data rate is limited by the electrical components used to sum the electrical signals.

The present invention has arisen in an endeavour to provide a multi-level optical signal generator which at least in part alleviates the limitations of the known arrangements.

According to the present invention a multi-level optical signal generator for generating a multi-level optical signal in response to two or more electrical signals comprises: light source means operable to produce a respective optical signal for each electrical signal, optical modulating means for modulating each optical signal in response to its respective electrical signal and combining means for combining the two or more modulated optical signals to produce the multi-level optical signal.

Preferably the light source means comprises a light source and splitting means for splitting the light output to produce the two or more optical signals. In an alternative arrangement a respective light source is provided to generate the two or more optical signals. The optical signals can be unmodulated such that the multi-level optical signal uses a non-return to zero (NRZ). Alternatively when it is desired to generate a multi-level optical signal having a return to zero (RZ) signalling format the optical signals can be appropriately modulated or the multi-level signal appropriately gated.

Preferably each of the optical signals has substantially the same amplitude and the generator further comprises a respective optical attenuator associated with all but one modulating means whose attenuation is selected to generate a selected optical level. Preferably the attenuation of the or each optical attenuator is selected such that the levels of the multi-level optical signal are quadratically spaced. Alternatively the attenuation of the or each optical attenuator is selected such that the levels of the multi-level optical signal are equally spaced. As an alternative to using one or more optical attenuators the light source means is operable such that the optical signals each have a selected amplitude.

Advantageously the generator further comprises a respective optical phase shifting means associated with all but one modulating means and whose phase shift is selected to ensure that all of the two or more modulated optical signals are in phase when they are combined.

Preferably the optical modulating means comprises an electro-optic optical modulator, most preferably a Mach Zehnder optical modulator or a coupled waveguide device such as a directional coupler.

In order that the invention can be better understood two multilevel optical signal generators in accordance with the invention will now be described, by way of example only, with reference to the accompanying drawings in which:

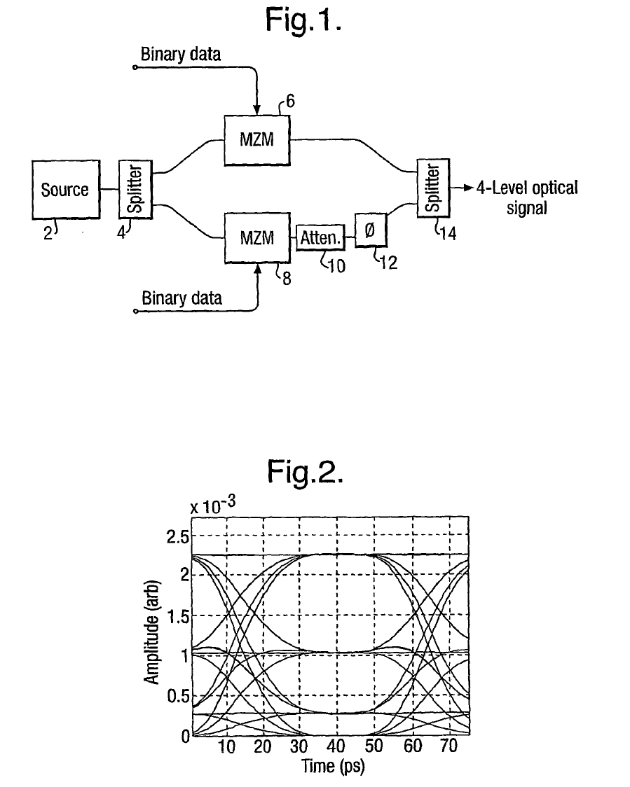

FIG. 1 is a schematic representation of a 4-level (4-ary) optical signal generator in accordance with the invention;

FIG. 2 is a simulated “eye” diagram (superposition of optical amplitude versus time) for the generator of FIG. 1 using non-return to zero signalling;

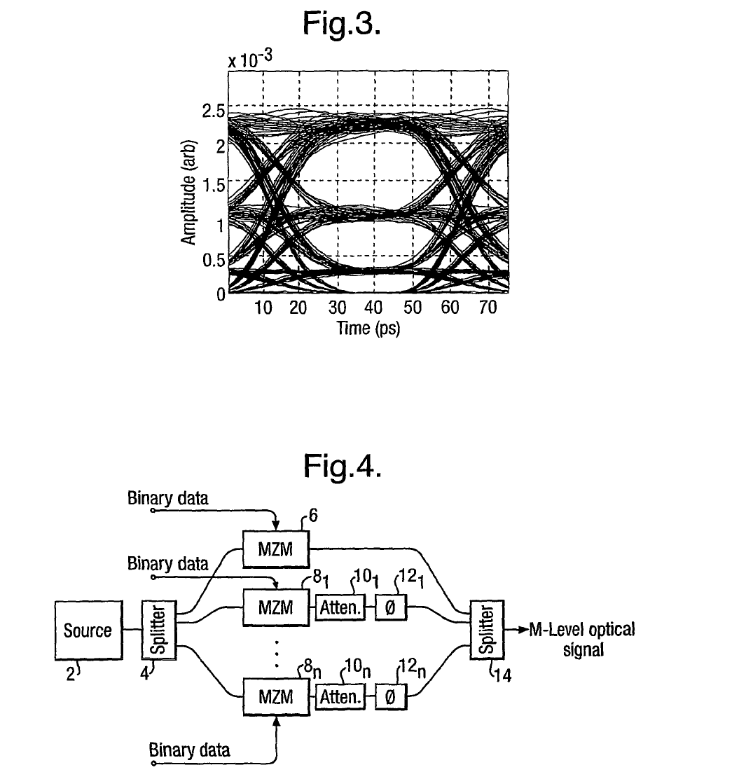

FIG. 3 is the simulated “eye” diagram of FIG. 2 which further illustrates the effect of Signal-ASE noise;

FIG. 4 is a schematic representation of an M-level (M-ary) optical signal generator in accordance with the invention; and

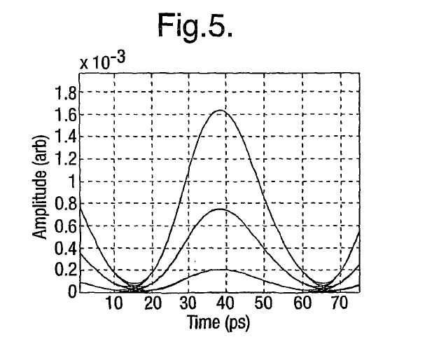

FIG. 5 is a simulated “eye” diagram for a 4-level (4-ary) optical signal using return to zero signalling.

Referring to FIG. 1 there is shown a multi-level optical generator for generating a 4-level (4-ary) optical signal which uses a non-return to zero signalling format and in which the four levels are quadratically spaced. Typically the generator would be used as part of a transmitter in a WDM optical communications system.

The generator comprises a light source 2, most typically a diode laser, which is operated to produce a continuous wave (CW), that is unmodulated, light output. The CW output is applied to an input of an optical splitter 4 which divides the light output into two (log₂M where M is the number of levels i.e. 4 in this example) CW optical signals having substantially the same amplitude. The optical splitter 4 preferably comprises a multi-mode interference (MMI) waveguide splitter though it will be appreciated that other forms of splitters can be used. The first of these CW signals is applied to an input of a first electro-optic modulator 6, typically a Mach Zehnder Modulator (MZM), which modulates the optical signal in response to a first electrical binary NRZ data signal. In a like manner the second CW optical signal is applied to an input of a second electro-optic modulator 8, typically a Mach Zehnder Modulator (MZM), which modulates this optical signal in response to a second electrical binary NRZ data signal. Both modulators 6, 8 are operated on a part of their optical transmission versus drive voltage characteristic such that they operate in an on-off (binary) fashion to modulate their respective CW optical signal input. As will be appreciated the two binary data signals are appropriately synchronised.

Connected to the output of the second modulator 8 there is provided a serially connected fixed optical attenuator 10 and a fixed optical phase shifter 12. An optical combiner 14 connected to the output of the first modulator 6 and to the output of the phase shifter 12 combines the two modulated optical signals to form the 4-ary optical signal. The optical combiner 14 preferably comprises an MMI device though other types of combiners can be used.

The fixed optical attenuator 10 attenuates the second modulated optical signal by 6 dB, that is by a quarter, and the fixed optical phase shifter 12 is set to ensure in-phase addition of the two modulated optical signals into the output waveguide of the combiner 14.

Referring to FIG. 2 there is shown a plot of the simulated optical amplitude versus time for the optical generator of FIG. 1. The plot shows the superposition of optical amplitude versus time that can result from all possible sequences of the two binary data signals and is often termed an “eye” diagram on account of its resemblance to an eye. As will be noted from this Figure the optical signal can take one of four levels (amplitudes), denoted 20, 22, 24, 26 in the Figure. The level depends upon the data state of the two binary signals. For example an optical signal of level 20 (no amplitude) will be produced when the two binary signals each correspond with a “low” state. Level 22 will be produced when the binary signal applied to the first modulator 6 has a “low” state and the binary signal applied to the second modulator 8 has a “high” state. Level 24 will be produced when the first binary signal is “high” and the second “low” and level 26 produced when both signals each correspond with a binary “high” state.

Referring to FIG. 3 a further simulated “eye” diagram for the generator of FIG. 1 is shown with the addition of Signal-ASE noise. It will be appreciated from this Figure how the use of a quadratic level spacing provides a substantially equal probability of error for thresholding any level.

If it is assumed that Signal-ASE noise is the only degradation in the optical communication system, 4-level signalling with a quadratic spacing of the levels will require an average optical power which is 5.4 dB higher than binary signalling for a given net data transmission rate, though the 4-level signalling can improve the spectral efficiency by up to 5 times (bit/s/Hz). In comparison to 4-level signalling using a linear spacing, 4-level quadratic spacing requires 6 dB lower average optical power to achieve an acceptable BER for a given data transmission rate. This significant reduction in required optical power compared to equally-spaced levels makes the use of multi-level signalling with quadratic spacing a practical reality since it minimises the impairments due to optical nonlinearity which arise with increasing optical power.

Referring to FIG. 4 there is shown a schematic representation of a multi-level optical generator in accordance with the invention which is operable to produce an M-level, M-ary, optical signal, that is a multilevel optical signal capable of conveying log₂(M) binary data signals. For consistency the same reference numerals are used to denote parts which are equivalent to the generator of FIG. 1. The log₂(M−1) fixed optical attenuators 10₁ to 10ₙ (as illustrated) are arranged to give attenuation of the optical power as follows. Designating the various arms of the generator by n=0,1, . . . log₂(M), the attenuation of the m^{th} arm, for m>0, is given by 1/(2^{2m}). Since, through the use of the optical phase shifter in all but the first arm, the modulated optical signals from all arms add in-phase and this results in the possible levels of the optical output signal having a quadratic spacing.

It will be appreciated that the present invention is not limited to the specific embodiment illustrated and that variations can be made which are within the scope of the invention. For example the generator can be used to generate multi-level optical signals using return to zero (RZ) signalling by using a pulsed optical source at the input, or alternatively a gating arrangement at the output. Conveniently a pulsed optical source can be realised through the addition of a further optical modulator between the laser 2 and splitter 4 or by using a pulsed optical source as disclosed in our co-pending patent application GB 0017937.4. An example of a simulated eye diagram for a 4-level optical signal using a RZ signalling format is illustrated in FIG. 5. Whilst as described the use of quadratically spaced levels is much preferred it will be appreciated that, if desired, a multi-level optical signal having equally spaced levels can be readily generated using the generator of the present invention by appropriate selection of the attenuation values of the fixed attenuators and selected phase shifts. Although in the example the constituent components of the generator are described as being discrete devices, in a preferred implementation the splitter, modulators, attenuators, phase shifters and combiner are fabricated as an integrated waveguide device in Gallium Arsenide or another III-V semiconductor material. Furthermore whilst it is convenient to generate the log₂(M) CW optical signals using a single light source and splitter it is also envisaged to use a respective light source for each arm in which the sources are phase correlated to each other. With such an arrangement the fixed attenuator could further be dispensed with if each light source is operated to generate an optical output with the selected optical amplitude.

For optimum performance the phase shifters are set to ensure in-phase addition of the modulated optical signals to form the M-ary optical signal. To compensate for drift or temperature effects is preferred to additionally provide means for monitoring and controlling the or each phase shifter. For a generator which is operated to provide a quadratic spacing of the levels the average optical power of the M-ary optical signal will be a maximum when the, or each, phase shift is optimised. Thus in one arrangement it is envisaged the average optical output power is measured using a slow photodetector (that is a detector having a time contact which is slow compared to the modulation rate) and the measured power used as part of a feedback arrangement to control the operation of the phase shifters. When the generator is fabricated in Gallium Arsenide it is preferred to measure the optical power within the output waveguide using two-photon absorption as described in our patent GB 2339278. Such an arrangement provides a low loss method of measuring optical power and provides increased contrast compared to a linear photodetector.

1. Multi-level optical signal generator for generating a multilevel optical signal in response to two or more electrical signals comprising: light source means operable to produce a respective optical signal for each electrical signal; optical modulating means for modulating each optical signal in response to its respective electrical signal and combining means for combining the two or more modulated optical signals to produce the multi-level optical signal.

2. Multi-level optical signal generator according to claim 1 in which the light source comprises a light source and splitting means for splitting the light output to produce the two or more optical signals.

3. Multi-level optical signal generator according to claim 1 or claim 2 and further comprising a respective optical attenuator associated with all but one modulating means whose attenuation is selected to generate a selected optical level

4. Multi-level optical signal generator according to claim 3 in which the attenuation of the or each optical attenuator is selected such that the levels of the multi-level optical signal are quadratically spaced.

5. Multi-level optical signal generator according to claim 3 in which the attenuation of the or each optical attenuator is selected such that the levels of the multi-level optical signal are equally spaced.

6. Multi-level optical signal generator according to any preceding claim and further comprising a respective optical phase shifting means associated with all but one modulating means and whose phase shift is selected to ensure all the two or more modulated optical signals are in phase when they are combined.

7. Multi-level optical signal generator according to any preceding claim in which the optical modulating means comprises an electro-optic optical modulator.

8. Multi-level optical signal generator according to any preceding claim in which the optical modulator is a Mach Zehnder optical modulator or coupled waveguide device.

9. Multi-level optical signal generator substantially as hereinbefore described with reference to, or substantially as illustrated in FIG. 1 or FIG. 4 of the accompanying drawings.
